(19) United States
(12) Patent Application Publication
(10) Pub. No.: US 2008/0212983 A1
(43) Pub. Date: Sep. 4, 2008

(54) IMAGE FORMING APPARATUS AND CONTROL METHOD THEREOF

(76) Inventors: Sang Gyu Park, Seoul (KR); Ui Choon Lee, Suwon-si (KR)

Correspondence Address: STANZIONE & KIM, LLP, 919 18TH STREET, N.W., SUITE 440, WASHINGTON, DC, 20006, US

(21) Appl. No.: 12/025,265

(22) Filed: Feb. 4, 2008

(30) Foreign Application Priority Data
Feb. 6, 2007 (KR) 2007-12155
Jan. 11, 2008 (KR) 2008-3421

(51) Int. Cl. G03G 15/00

(52) U.S. Cl. 399/18

(57) ABSTRACT

In an image forming apparatus and a control method thereof, it is determined whether an error has occurred in an output signal of a sensor for detecting a paper transferred in order to print an image, and a state change permission interval with respect to the output signal is newly set when the output signal is in an abnormal state, so that the detection time of the paper can be precisely recognized.

### CROSS-REFERENCE TO RELATED APPLICATIONS

This application claims priority under 35 U.S.C. §119(a) from the benefit of Korean Patent Application No. 2007-12155 filed on Feb. 6, 2007 and No 2008-3421 filed on Jan. 11, 2008, in the Korean Intellectual Property Office, the disclosure of which is incorporated herein in its entirety by reference.

### BACKGROUND OF THE INVENTION

1. Field of the Invention

The present general inventive concept relates to an image forming apparatus to control timing of various signals required in a printing operation according to a state of a sensor to detect a sheet of paper, and a control method of the image forming apparatus.

2. Description of the Related Art

An image forming apparatus has a sensor for detecting a sheet of paper transferred along a paper transfer path in order to control a series of operation processes of developing, transferring, fixing and discharging after picking up a paper.

As illustrated in FIG. 1, a sensor 10 for detecting a paper includes a probe 11 coming into contact with a front end of the paper passing between feeding rollers 20 for supplying the paper, a connection member 12 connected to the probe 11 to transmit movement of the probe 11 coming into contact with the paper, and a signal output part 13 for outputting a sensor signal for recognizing the detection of the paper in accordance with the movement transmitted through the connection member 12.

The signal output part 13 comprises a pair of a light emitting unit and a light receiving unit. An output of the light receiving unit is changed when light emitted from the light emitting unit is blocked by the connection member 12. An output signal of the sensor 10 is changed according to the output of the light receiving unit.

When the paper passes through the probe 11, the output signal of the sensor 10 is changed from an off state to an on state at a predetermined time as illustrated in FIG. 2A, and a controller controls an entire operation for a printing job in accordance with the output signal of the sensor 10. At this time, since the output signal of the sensor 10 may be temporarily changed due to malfunction of the sensor 10 although the sensor 10 is not broken, paper detection may be abnormally recognized if an output state of the sensor 10 is detected when the sensor output is changed for the first time. For example, when the paper does not make contact with the sensor 10 by passing the sensor 10, a distance between the connection member 12 and the signal output part 13 may be changed. At this time, chattering phenomenon may occur, so that the output signal of the sensor 10 is repeatedly changed.

In an effort to solve the problem, a predetermined margin is set from the time when the output signal of the sensor 10 is changed for the first time. This margin is set in advance in order to stably recognize the output state of the sensor 10. Substantially, the margin denotes an interval in which the controller does not recognize a signal state of the sensor 10 and a change in the output signal of the sensor 10 is permitted. Such a state change permission interval for the output signal of the sensor 10 is for stably recognizing the output signal of the sensor 10.

As illustrated in FIG. 2B, a state change permission interval Mb for the output signal of the sensor 10 corresponds to an interval between a time ptp, at which an output signal is changed from an off state to an on state, and a time ta, which is obtained when a predetermined time has lapsed from the time tp.

As the printing operation continues, abrasion occurs at various parts of the sensor 10. Therefore, an output characteristic of the sensor 10 may be changed. In such a case, chattering may occur in the sensor output signal as illustrated in FIG. 2C.

If an interval (tp to tch) causing the chattering is longer than the state change permission interval Mb for the output signal of the sensor 10, it is difficult to precisely recognize the output signal of the sensor 10.

As described above, the output of the sensor 10 for paper detection is not normally recognized, so that various errors have occurred in other signals relating to the sensor output due to reliability deterioration.

For example, a printing synchronization signal Psync is generated during a printing operation as illustrated in FIG. 2D. The printing synchronization signal Psync is generated at the time after a predetermined time Pst has lapsed from an end time ta of the state change permission interval Mb for the output signal of the sensor 10.

However, if chattering occurs in the output signal of the sensor 10 for paper detection, it exerts influence upon the time for generating the printing synchronization signal Psync based on the output state of the sensor 10. Therefore, the image printed on the printing paper is distorted.

Further, the sensor 10 determines a paper jam based on a detection time of the paper while the paper is being transferred. However, since the paper detection time is inaccurate due to chattering having occurred in the output signal of the sensor 10, an error may occur when determining the paper jam.

Furthermore, a feeding time for a subsequent paper may be abnormally determined due to an error in the sensor output signal.

### SUMMARY OF THE INVENTION

The present general inventive concept provides an image forming apparatus capable of precisely recognizing detection of a sheet of paper regardless of an error in an output signal of a sensor to detect the paper, and a control method of the image forming apparatus

Additional aspects and utilities of the present general inventive concept will be set forth in part in the description which follows and, in part, will be obvious from the description, or may be learned by practice of the general inventive concept

The foregoing and/or other aspects and utilities of the present general inventive concept may be achieved by providing an image forming apparatus including a sensor to detect a sheet of paper transferred along a transfer path, and a controller to detect whether the sensor is in a normal state using an output signal of the sensor, and to newly set a state change permission interval with respect to the output signal when the sensor is in an abnormal state.

When the paper passes the sensor, a state of the output signal of the sensor is toggled, and the controller may determine whether the sensor is in a normal state based on a number of toggles of the output signal.

The controller may generate a margin to include a period of chattering of the sensor when newly setting the state change permission interval with respect to the output signal.

The controller may newly set a time to generate one of related signals corresponding to the output signal in order to perform a printing operation according to the generated margin to include the period of chattering of the sensor.

The related signals corresponding to the output signal may include at least one of a printing synchronization signal, a jam check signal and a paper feeding signal.

The image forming apparatus may further include a storage unit to store a setting value corresponding to the state change permission interval with respect to the output signal.

The image forming apparatus may further include an interface unit to receive an input of a user such that the state change permission interval with respect to the output signal is set by the user.

The image forming apparatus may further include a display unit to display replacement necessity of the sensor.

The display unit may be provided in the image forming apparatus or a host device connected to the image forming apparatus.

The foregoing and/or other aspects and utilities of the present general inventive concept may also be achieved by providing a control method of an image forming apparatus, the control method including determining whether a sensor is in a normal state based on change in a state of an output signal of the sensor to detect a sheet of paper; and newly setting a state change permission interval with respect to the output signal when the sensor is in an abnormal state.

The determining of whether the sensor is in the normal state may include counting the number of toggles of the output signal, and determining whether the sensor is in the normal state by comparing the counted number of toggles with a reference value.

When the state change permission interval with respect to the output signal is newly set, a margin to include a period of chattering of the sensor is corrected.

The control method may further include newly setting related signals corresponding to the output signal in order to perform a printing operation according to correction of the margin for chattering of the sensor when the state change permission interval for the output signal is newly set.

The newly setting of the related signals corresponding to the output signal may include at least one of setting a time to generate a printing synchronization signal to start a printing operation to print an image on a sheet of paper, setting a time to generate a jam check signal to check a paper jam, and setting a time to generate a paper feeding signal to feed a subsequent paper.

The control method may further include displaying replacement necessity of the sensor when the state change permission interval with respect to the output signal is newly set.

The newly setting of the state change permission interval with respect to the output signal may further include manually setting the state change permission interval by using input of a user received through a user interface unit.

The foregoing and/or other aspects and utilities of the present general inventive concept may also be achieved by providing a computer-readable medium to contain computer-readable codes as a program to execute a control method of an image forming apparatus, the control method including determining whether a sensor is in a normal state based on change in a state of an output signal of the sensor to detect a sheet of paper, and newly setting a state change permission interval with respect to the output signal when the sensor is in an abnormal state.

The foregoing and/or other aspects and utilities of the present general inventive concept may also be achieved by providing. An image forming apparatus including a sensor to detect a sheet of paper to generate an output signal, and a controller to generate a signal to perform a printing operation according to a time of the output signal, and a variable period to vary from the time of the output signal according to a state of the output signal.

The controller may determine the time of the output signal when the output signal is changed from an off state to an on state, may determine the variable period according to the state of a characteristic of the output signal, may determine a variable time according to an end of the characteristic of the output signal, and may generate the signal according to the time, the variable period, and the variable time.

The characteristic of the output signal may include chattering.

The controller may determine another variable period determined from the variable period according to a characteristic of the signal corresponding to the printing operation, and may generate the signal according to the period, the variable period, and another variable period.

The signal may include at least one of a printing synchronization signal to start the printing operation, a jam check signal, and a paper feeding signal to feed another sheet of paper.

The controller may set a time period from the variable period to generate the printing synchronization signal, adjust the set time period to another time period according to a characteristic of chattering of the output signal, and generate the printing synchronization signal according to the another time period.

The foregoing and/or other aspects and utilities of the present general inventive concept may also be achieved by providing an image forming apparatus including a sensor to detect a sheet of paper to generate first and second output signals, and a controller to generate a signal to perform a printing operation according to a time of the first output signal, a first variable period to vary from the time of the first output signal according to a state of the first output signal, and a second variable period to vary from the first variable period according to a state of the second output signal.

### BRIEF DESCRIPTION OF THE DRAWINGS

The above and other objects, features and advantages of the present general inventive concept will be more apparent from the following detailed description taken in conjunction with the accompanying drawings, in which:

FIG. 1 is a view illustrating a configuration of a sensor that detects a paper;

FIG. 2A is view illustrating a normal output signal of a sensor;

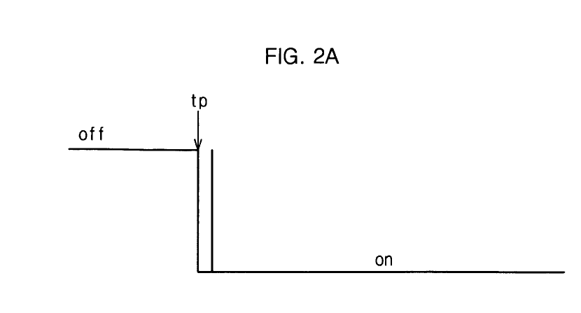

FIG. 2B is a view illustrating a state change permission interval with respect to the output signal in FIG. 2A;

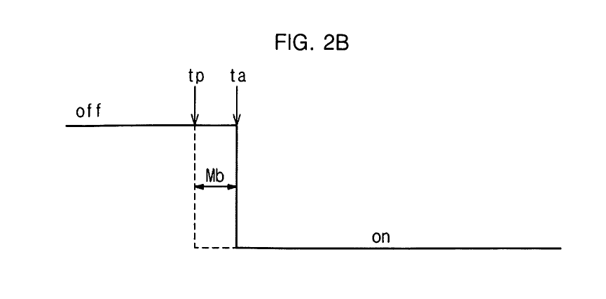

FIG. 2C is a view illustrating an output signal of a sensor when chattering is generated in the output signal due to abrasion of a sensor;

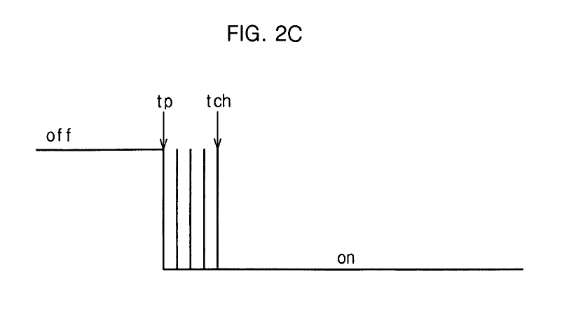

FIG. 2D is a view illustrating an operation of setting a printing synchronization signal according to an output signal of a sensor;

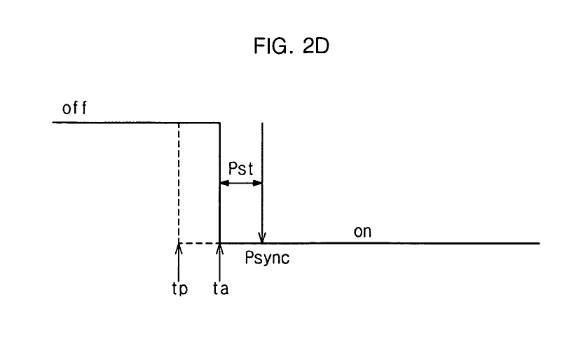

FIG. 3 is a block diagram illustrating an image forming apparatus according to an embodiment of the present general inventive concept;

FIG. 4 is a view illustrating operations of setting a state change permission interval with respect to an output signal of a sensor, and setting other signals relating to the state change permission interval in an image forming apparatus according to an embodiment of the present general inventive concept; and

FIG. 5 is a flowchart illustrating a control method of an image forming apparatus according to an embodiment of the present general inventive concept.

### DETAILED DESCRIPTION OF THE PREFERRED EMBODIMENTS

Hereinafter, an image forming apparatus and a control method thereof according to an exemplary embodiment of the present general inventive concept will be described with reference to the accompanying drawings. Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

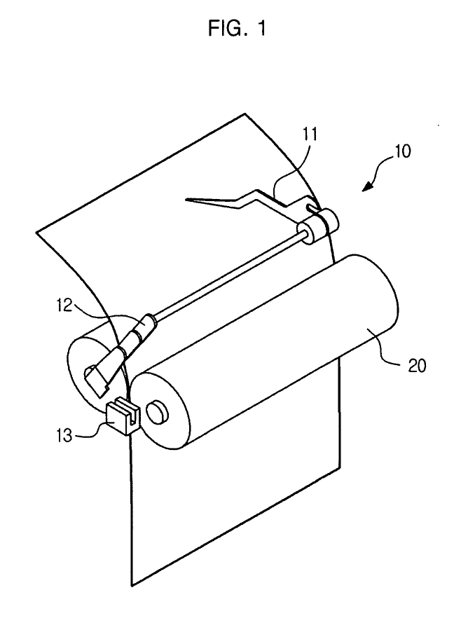

An image forming apparatus according to the present general inventive concept may include a sensor to detect a sheet of paper transferred along a paper transfer path. Here, the sensor applied to the present general inventive concept may have a structure similar to that of a sensor illustrated in FIG. 1, so the same numerals will be assigned to the same elements.

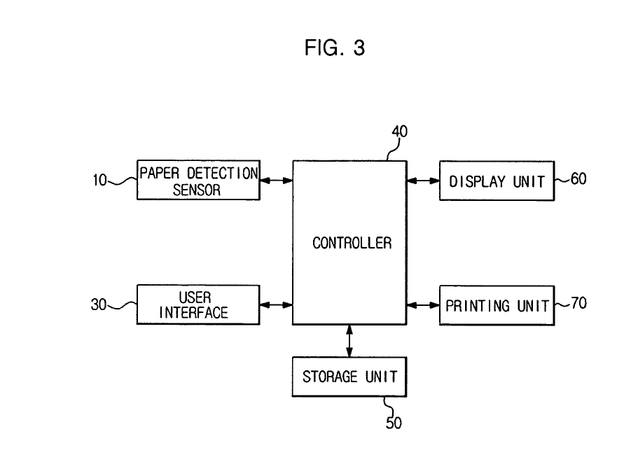

As illustrated in FIG. 3, the image forming apparatus according to the present general inventive concept may include a paper detection sensor 10 mounted on a paper transfer path to detect a front end of a sheet of paper, a user interface 30, a controller 40, a storage unit 50 and a display unit 60. The image forming apparatus may further include a printing unit 70 to form an image on the paper in a printing operation. The user interface 30 and the display unit 60 are provided at a manipulation panel of the image forming apparatus. However, the present general inventive concept is not limited thereto. The user interface 30 and the display unit 60 may be provided at a host device (i.e., a personal computer) connected to the image forming apparatus.

The paper detection sensor unit 10 may include a probe 11, a connection member 12 and a signal output part 13 as illustrated in FIG. 1.

If a paper transferred along the paper transfer path makes contact with the probe 11, an output signal of the signal output part 13 of the sensor unit 10 is changed from an off state to an on state.

The controller 40 controls entire operations of performing the printing operation in accordance with a user setting instruction input through the user interface 30.

When starting the printing operation, the output signal of the paper detection sensor 10 is provided to the controller 40. The controller 40 recognizes a detection time of a sheet of paper in accordance with the output signal of the paper detection sensor unit 10. At this time, the controller 40 determines if chattering has occurred in the output signal provided from the paper detection sensor unit 10. If the chattering has excessively occurred in the output signal of the paper detection sensor unit 10, the controller 40 sets a state change permission interval with respect to the sensor output signal. Here, a setting value to set the state change permission interval is stored in the storage unit 50.

When the state change permission interval with respect to the sensor output signal is set, the controller 40 sets a time to generate a printing synchronization signal Psync to determine a time to print an image on a sheet of paper in the printing operation. Further, the controller 40 controls various signals to perform the printing operation such as a jam check signal Jt to check a paper jam, and a paper feeding signal Pt to determine a feeding time of a subsequent sheet of paper to be fed.

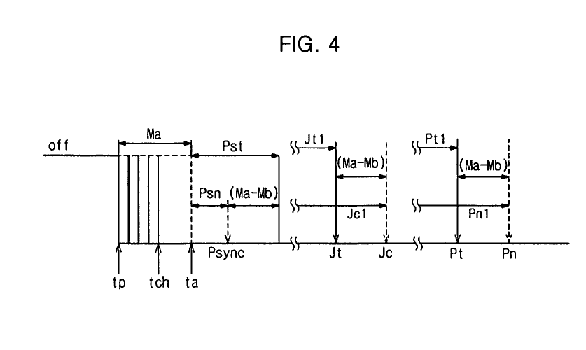

Referring to FIG. 4, the sensor unit 10 outputs an off-state signal before the paper makes contact with the probe 11. When a front end of the paper makes contact with the probe 11 of the sensor unit 10 at a predetermined time tp, the signal output part 13 detects a movement of the connection member 12 to output an on-state signal.

The controller 40 counts the number of toggles of the output signal of the sensor unit 10 so as to check whether chattering has occurred in the output signal provided from the sensor unit 10. Then, the controller 40 compares the number of toggles with a reference value. If the chattering has excessively occurred, i.e., if the counted number of toggles is larger than the reference value, the controller 40 newly sets a state change permission interval Ma with respect to the output signal by using information stored in the storage unit 50. The state change permission interval Ma is set to be large enough to contain a time tch at which the chattering ends. The time tch may be a period of chattering with respect to the output signal.

The state change permission interval Ma may vary according to the information stored in the storage unit 50. The information may be an index or a reference value to indicate each of a plurality of periods with respect to the output signal according to a difference between the number of toggles and the reference value.

The toggling may occur when the sensor unit 10 cannot detect the paper, repeatedly detect the paper, or repeats an operation to alternatively generate the on state signal and the off state signal due to a defect of the sensor unit 10 or an incomplete operation of the sensor unit 10 during detecting the paper, so that chattering occurs in the output signal of the sensor unit 10. Accordingly, one or more delayed output signals or another output signals are generated as toggling. The toggling is represented as a period from an initial operation of generating the on state signal changed from the off state signal.

When setting the state change permission interval Ma with respect to the output signal, the controller 40 generates the printing synchronization signal Psync after a new setting time Psn obtained with respect to an initial setting time Pst which is a set period from the set state change permission interval Ma.

If a printing synchronization signal is generated after the initial setting time Pst from the time ta at which the newly set state change permission interval Ma ends, the printing synchronization signal is delayed with respect to the output signal. Thus, the controller 40 generates the printing synchronization signal Psync after the new setting time Psn from the time ta at which the newly set state change permission interval Ma ends.

The setting time Psn is defined by an equation below.

Psn=Pst−(Ma−Mb). Here, Mb is a period (or interval) to correspond to a difference between the time tch and the time ta. The period Mb may be another period shorter than the period representing the difference between the time tch and the time ta. The period Mb may be a period between the time tch and another time tch.

As the state change permission interval Ma is newly set with respect to the sensor output signal according to an amount (period), of the chattering occurring in the sensor output signal, the time to generate the initially set jam check signal Jt and the time to generate the initially set paper feeding signal Pt must be newly set. The initial jam check signal Jt is generated based on the initial setting time Jt1 and the initial paper feeding signal Pt is also generated based on the initial setting time Pn1.

The controller 40 sets a time to generate a jam check signal so as to check the paper jam after the new setting time Jc1 obtained by changing the initial setting time Jt1. That is, the controller 40 generates a new jam check signal Jc after the new setting time Jc1 from the time ta at which the newly set state change permission interval Ma ends.

Further, the controller 40 sets a time to generate a paper feeding signal so as to feed a subsequent sheet of paper after the new setting time Pc1 obtained by changing the initial setting time Pt1. That is, the controller 40 generates a new jam check signal Pn after the new setting time Pn1 from the time ta at which the newly set state change permission interval Ma ends.

A relation between the initially set jam check signal Jt and the new jam check signal Jc, and a relation between the initially set paper feeding signal Pt and the new paper feeding signal Pc are defined by equations below.

Jc=Jt+(Ma−Mb)

Pn=Pt+(Ma−Mb)

The controller 40 checks the paper jam in accordance with the changed jam check signal Jc instead of the initial jam check signal Jt. In addition, the controller 40 determines the feeding time of a subsequent paper to be printed in accordance with the changed paper feeding signal Pn instead of the initial paper feeding signal Pt.

Although the state change permission interval with respect to the sensor output signal, the jam check signal and the paper feeding signal are newly set as described above, excessive chattering phenomenon may occur in the sensor output signal during a printing operation, causing deterioration of reliability for recognition of the output state of the sensor, a checking operation of the paper jam, and a paper feeding operation.

In such a case, a user must manually set the state change permission interval for the sensor output signal, the jam check signal and the paper feeding signal. To this end, the controller 40 displays a message to manually set the above-signals through the display unit 60. If an input is received from a user through the user interface 30, the controller 40 newly sets the time to generate the state change permission interval for the sensor output signal, the jam check signal and the paper feeding signal in accordance with the input of the user.

It is possible that the state change permission interval may be automatically set according to the excessive chattering and a reference. That is, the state change permission interval can be adjusted according to a difference between the excessive chattering and the reference.

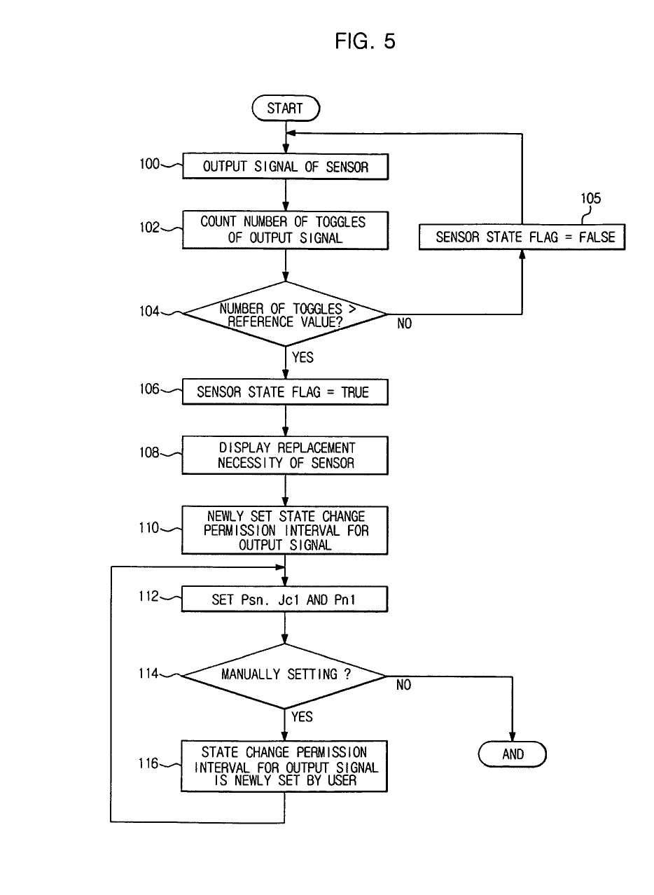

Hereinafter, a control method of the image forming apparatus according to the present general inventive concept will be described with reference to FIG. 5.

Referring to FIGS. 3, 4, and 5, when the image forming apparatus is powered on, an initialization operation is performed to carry out a printing operation, and the paper detection sensor 10 provides the controller 40 with an output signal based on paper detection at operation 100.

The controller 40 counts the number of toggles of the output signal at operation 102, and determines whether the counted number of toggles is larger than a preset reference value at operation 104. If it is determined that the counted number of toggles is not larger than the reference value, the controller 40 sets a sensor state flag as FALSE at operation 105 and then returns to operation 100.

If it is determined at the operation 104 that the counted number of toggles is larger than the reference value, the controller 40 sets the sensor state flag as TRUE at operation 106, and controls replacement necessity of the sensor 10 to be displayed through the display unit 60 such that a user can identify the fact that chattering excessively occurs due to abrasion of the sensor 10 at operation 108.

Then, the controller 40 newly sets a state change permission interval with respect to the sensor output signal on the basis of information of a setting value stored in the storage unit 50 at operation 110.

After that, the controller 40 newly sets the setting time Psn to determine the time to generate a printing synchronization signal, setting a time Jc1 to determine the time to generate a jam check signal, and a paper feeding time Pn1 to determine the time to generate a paper feeding signal in accordance with the new state change permission interval. The controller 40 generates a new printing synchronization signal, a jam check signal, and a paper feeding signal, respectively, in accordance with the setting time, thereby performing a printing operation at operation 112.

However, although the printing operation has been performed after various signals to perform the printing operation are newly set, excessive chattering may occur in the output signal. Further, the frequency, by which the paper jam occurs, may not be reduced or a subsequent paper may not be fed at a proper time. In such a case, a user can manually set various signals to perform the printing operation. The set various signals can be automatically set to perform the printing operation.

The chattering may correspond to the toggling. The toggling occurs in detecting the paper, and the chattering occurs in the output signal according to the toggling.

When an amount (or period) of the chattering is greater than a value, that is, the amount (or period) of the chattering is an excessive amount (or period), the state change permission interval may be automatically set according to an amount of the excessive chattering. That is, the state change permission interval can be adjusted according to a difference between the excessive chattering and a reference.

That is, the controller 40 controls the display unit 60 to display a message to identify whether a user's request for manually setting various signals to perform the printing operation exists, and determines whether a user's request instruction for the message is input at operation 114. In the case where it is determined that the user's request instruction for manual setting does not exist, the control method ends.

In the case where the user's request instruction for manual setting exists, the state change permission interval for the sensor output signal is newly set in accordance with the user's request instruction at operation 116. Then, the controller 40 returns to operation 112 so as to newly set various setting time based on the state change permission interval for the sensor output signal, which is manually set by the user, and generates new printing synchronization, jam check and paper feeding signals, respectively, in accordance with the setting time, thereby performing a printing operation.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to the present general inventive concept, although an error occurs in an output signal of a sensor for detecting a paper, the state change permission interval with respect to the sensor output signal is newly set, so that a detection time of a paper can be precisely recognized.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a sensor to detect a sheet of paper transferred along a transfer path; and
a controller to determine whether the sensor is in a normal state using an output signal of the sensor, and to newly set a state change permission interval with respect to the output signal when the sensor is in an abnormal state.

2. The image forming apparatus of claim 1, wherein a state of the output signal of the sensor is toggled when the sensor does not make contact with the paper, and the controller determines whether the sensor is in the normal state based on the number of toggles of the output signal.

3. The image forming apparatus of claim 1, wherein the controller corrects a margin to include a period of chattering of the sensor when newly setting the state change permission interval with respect to the output signal.

4. The image forming apparatus of claim 3, wherein the controller newly sets a time to generate at least one of related signals corresponding to the output signal in order to perform a printing operation according to the corrected margin.

5. The image forming apparatus of claim 4, wherein the related signals corresponding to the output signal comprise at least one of a printing synchronization signal, a jam check signal and a paper feeding signal.

6. The image forming apparatus of claim 1, further comprising:
a storage unit to store a setting value corresponding to the state change permission interval with respect to the output signal.

7. The image forming apparatus of claim 1, further comprising:
an interface unit to receive an input of a user such that the state change permission interval with respect to the output signal is set by the user.

8. The image forming apparatus of claim 1, further comprising:
a display unit to display replacement of the sensor.

9. The image forming apparatus of claim 8, wherein the display unit is provided in the image forming apparatus or a host device connected to the image forming apparatus to control a printing operation thereof.

10. A control method of an image forming apparatus, the control method comprising:
determining whether a sensor is in a normal state based on change in a state of an output signal of the sensor to detect a sheet of paper; and
newly setting a state change permission interval with respect to the output signal when the sensor is in an abnormal state.

11. The control method of claim 10, wherein the determining of whether the sensor is in the normal state comprises:
counting the number of toggles of the output signal; and
determining whether the sensor is in the normal state by comparing the counted number of toggles with a reference value.

12. The control method of claim 10, wherein a margin to include a period of chattering of the sensor is corrected when the state change permission interval with respect to the output signal is newly set.

13. The control method of claim 12, further comprising:
newly setting related signals corresponding to the output signal in order to perform a printing operation according to correction of the margin when the state change permission interval is newly set with respect to the output signal.

14. The control method of claim 13, wherein the newly setting of the related signals corresponding to the output signal comprises at least one of setting a time to generate a printing synchronization signal to start the printing operation to print an image on the paper, setting a time to generate a jam check signal to check a paper jam, and setting a time to generate a paper feeding signal to feed a subsequent sheet of paper.

15. The control method of claim 10, further comprising:
displaying replacement of the sensor when the state change permission interval is newly set with respect to the output signal.

16. The control method of claim 10, wherein the newly setting of the state change permission interval with respect to the output signal further comprises manually setting the state change permission interval by using an input of a user received through a user interface unit.

17. A computer-readable medium to contain computer-readable codes as a program to execute a control method of an image forming apparatus, the control method comprising:
determining whether a sensor is in a normal state based on change in a state of an output signal of the sensor to detect a sheet of paper; and
newly setting a state change permission interval with respect to the output signal when the sensor is in an abnormal state.

18. An image forming apparatus comprising:
a sensor to detect a sheet of paper to generate an output signal; and
a controller to generate a signal to perform a printing operation according to a time of the output signal, and a variable period to vary from the time of the output signal according to a state of the output signal.

19. The image forming apparatus of claim 18, wherein:
the controller determines the time of the output signal when the output signal is changed from an off state to an on state, determines the variable period according to the state of a characteristic of the output signal, and determines a variable time according to an end of the characteristic of the output signal, and
the controller generates the signal according to the time, the variable period, and the variable time.

20. The image forming apparatus of claim 19, wherein the characteristic of the output signal comprises chattering.

21. The image forming apparatus of claim 18, wherein the controller determines another variable period determined from the variable period according to a characteristic of the signal corresponding to the printing operation, and generates the signal according to the period, the variable period, and another variable period.

22. The image forming apparatus of claim 18, wherein the signal comprises at least one of a printing synchronization signal to start the printing operation, a jam check signal, and a paper feeding signal to feed another sheet of paper.

23. The image forming apparatus of claim 22, wherein the controller sets a time period from the variable period to generate the printing synchronization signal, adjusts the set time period to another time period according to a characteristic of chattering of the output signal, and generates the printing synchronization signal according to the another time period.

24. An image forming apparatus comprising:
a sensor to detect a sheet of paper to generate first and second output signals; and
a controller to generate a signal to perform a printing operation according to a time of the first output signal, a first variable period to vary from the time of the first output signal according to a state of the first output signal, and a second variable period to vary from the first variable period according to a state of the second output signal.
